(19) United States
(12) Patent Application Publication
(10) Pub. No.: US 2025/0074291 A1
(43) Pub. Date: Mar. 6, 2025

(54) VEHICLE HEADLIGHT EVALUATION

(71) Applicant: QUALCOMM Incorporated, San Diego, CA (US)

(72) Inventors: Gustav Lars Henrik JAGBRANT, Linköping (SE); Gustav Nils Ture PERSSON, Ljungsbro (SE); Per CRONVALL, Linköping (SE)

(21) Appl. No.: 18/459,867

(22) Filed: Sep. 1, 2023

(51) Int. Cl. B60Q 1/08; B60Q 1/00; G06V 20/58

(52) U.S. Cl. CPC B60Q 1/085; B60Q 1/0023; B60Q 11/005; G01M 11/065; G06V 20/582; G06V 20/584; B60Q 2300/112; B60Q 2300/41; B60Q 2300/45

(57) ABSTRACT

A method of headlight evaluation can include receiving from a camera mounted on a vehicle, one or more images that include at least a portion of an illumination pattern projected by a headlight of the vehicle upon a surface of an object. The object can be a stationary object or a moving object such as, for example, a traffic sign or another vehicle. The surface can be a front portion of the traffic sign or a rear vertical surface of the other vehicle. The illumination pattern may be evaluated based on a positional relationship of the camera, the headlight, and the surface of the object. A headlight position status and/or a headlight orientation status can be output based on evaluating the illumination pattern.

### BACKGROUND

### 1. Field of Disclosure

The present disclosure relates generally to the field of vehicle operations, and more specifically to evaluating illumination produced by a vehicle headlight.

### 2. Description of Related Art

The headlights of a vehicle may get misaligned at times due to various reasons such as due to an accident, due to engine vibration, due to a manufacturing defect, temperature variations, and/or due to faulty installation. Misaligned headlights are undesirable because such headlights can provide poor illumination of the road and objects outside the vehicle and/or can dazzle oncoming motorists. A typical solution for this problem involves a technician inspecting the headlights, detecting a misalignment, and manually adjusting the headlights in accordance with calibration guidelines. The misalignment may be identified by the technician based on a visual observation of an illumination pattern produced by the headlights. This type of solution suffers from several drawbacks such as, for example, dependence on the personal judgement of the technician, time spent on performing the manual procedures, money spent on performing the manual procedures, and the inconvenience caused by the vehicle being unavailable for use by a driver of the vehicle.

### BRIEF SUMMARY

Embodiments described herein pertain to evaluating of a headlight of a vehicle. More particularly, in accordance with the disclosure, a method of headlight evaluation can include receiving from a camera mounted on a vehicle, one or more images that include at least a portion of an illumination pattern projected by a headlight of the vehicle upon a surface of an object. The object can be a stationary object or a moving object such as, for example, a traffic sign or another vehicle. The surface can be a front portion of the traffic sign or a rear vertical surface of the other vehicle. The illumination pattern may be evaluated based on a positional relationship of the camera, the headlight, and the surface of the object. A headlight position status and/or a headlight orientation status can be output based on evaluating the illumination pattern.

An example apparatus can include a camera mounted on a vehicle and a headlight evaluation system. The headlight evaluation system can include a memory and one or more processors communicatively coupled with the memory. The processor(s) are configured to receive from the camera, an image that includes at least a portion of an illumination pattern projected by a headlight of the vehicle upon a surface of an object. The processor(s) are further configured to evaluate the illumination pattern based on at least a positional relationship of the camera, the headlight, and the surface of the object, and output at least one of a headlight position status or a headlight orientation status based on evaluating the illumination pattern.

An example apparatus for headlight calibration can include means for receiving, from a camera mounted on a first vehicle, at least one image that includes at least a portion of an illumination pattern projected by a headlight of the first vehicle upon a surface of an object. The apparatus can further include means for evaluating the illumination pattern based on at least a positional relationship of the camera, the headlight, and the surface of the object, and means for outputting at least one of a headlight position status or a headlight orientation status based on evaluating the illumination pattern.

An example non-transitory computer-readable medium can store instructions for headlight evaluation. The instructions can include code for receiving from a camera mounted on a first vehicle, an image that includes at least a portion of an illumination pattern projected by a headlight of the first vehicle upon a surface of an object. The instructions can further include code for evaluating the illumination pattern based on at least a positional relationship of the camera, the headlight, and the surface of the object, and outputting at least one of a headlight position status or a headlight orientation status based on evaluating the illumination pattern.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

The detailed description below pertains to a few example embodiments that are illustrated in the accompanying drawings. However, it must be understood that the description is equally relevant to various other variations of the embodiments described herein. Such embodiments may utilize objects and/or components other than those illustrated in the drawings. It must also be understood that like reference numerals used in the various figures indicate similar or identical objects.

FIG. 1 shows an example vehicle that is configured to perform various operations associated with vehicle headlight evaluation according to an embodiment.

FIG. 2 illustrates an example illumination pattern projected by a headlight of the example vehicle of FIG. 1 upon a surface of an object in accordance with an embodiment of the disclosure.

FIG. 3 illustrates the example vehicle of FIG. 1 illuminating a surface of a moving object in accordance with an embodiment of the disclosure.

FIG. 4 illustrates an example scenario where an illumination pattern projected by a vehicle upon a surface of an object is overlapped by an illumination pattern projected by another vehicle.

FIG. 5 illustrates a geometric representation that defines a positional relationship between the example vehicle of FIG. 1 and a surface of an object in accordance with an embodiment of the disclosure.

FIG. 6 shows a geometric representation that may be used for evaluating an illumination pattern in accordance with the disclosure.

FIG. 7 shows a flow diagram of a method to evaluate a headlight of a vehicle in accordance with an embodiment of the disclosure.

FIG. 8 illustrates some example functional components of a vehicle that is configured to perform operations associated with vehicle headlight evaluation in accordance with the disclosure.

### DETAILED DESCRIPTION

Several illustrative examples will now be described with respect to the accompanying drawings, which form a part hereof. While particular examples, in which one or more aspects of the disclosure may be implemented, are described below, other examples may be used, and various modifications may be made without departing from the scope of the disclosure or the spirit of the appended claims.

Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, particular features, structures, or characteristics described herein may be combined in one or more examples.

The methodologies described herein may be implemented by various means depending upon applications according to particular examples. For example, such methodologies may be implemented in hardware, firmware, software, and/or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

As used herein, the word “vehicle” is not intended to be exclusive or limited to any specific type of vehicle. A few non-exhaustive examples of vehicles can include a sedan, a sports utility vehicle, a truck, a van, a minivan, a bus, a minibus, a recreational vehicle, a gasoline-operated vehicle, an electric vehicle, a hybrid electric vehicle, and a battery electric vehicle. The word “surface” as used herein refers to any surface upon which an illumination pattern can be projected. The surface can be a part of any of various stationary objects, moveable objects, or moving objects. The surface can be a flat surface in some cases, and a surface that is non-uniform (bumps, protrusions, depressions, curved, irregular, non-planar etc.) in some other cases.

As described above, misaligned headlights of a vehicle are undesirable because such headlights can provide poor illumination of the road and external objects to a driver of a vehicle and/or can dazzle oncoming motorists. A typical solution for this problem can involve a technician performing manual operations to identify and correct the misalignment. However, this type of conventional solution suffers from several drawbacks associated with time, cost, inconvenience etc.

Consequently, various aspects of the subject matter described herein in this disclosure can be implemented to realize one or more potential advantages. More particularly, in accordance with the disclosure, features associated with a headlight of a vehicle such as, for example, headlight position and/or headlight orientation, can be determined based on performing various actions that do not involve manual intervention. The actions, which may be carried out, for example, by one or more processors of a headlight evaluation system provided in a vehicle can include actions such as, receiving, from a camera mounted on the vehicle, an image that includes at least a portion of an illumination pattern projected by a headlight of the vehicle upon a surface of an object. The processor(s) can evaluate the illumination pattern based on a positional relationship of the camera, the headlight, and the surface of the object. A headlight position status and/or a headlight orientation status may be output based on evaluating the illumination pattern. In an example implementation, this output may be used by a headlight adjusting system provided in the vehicle to perform a headlight adjustment operation.

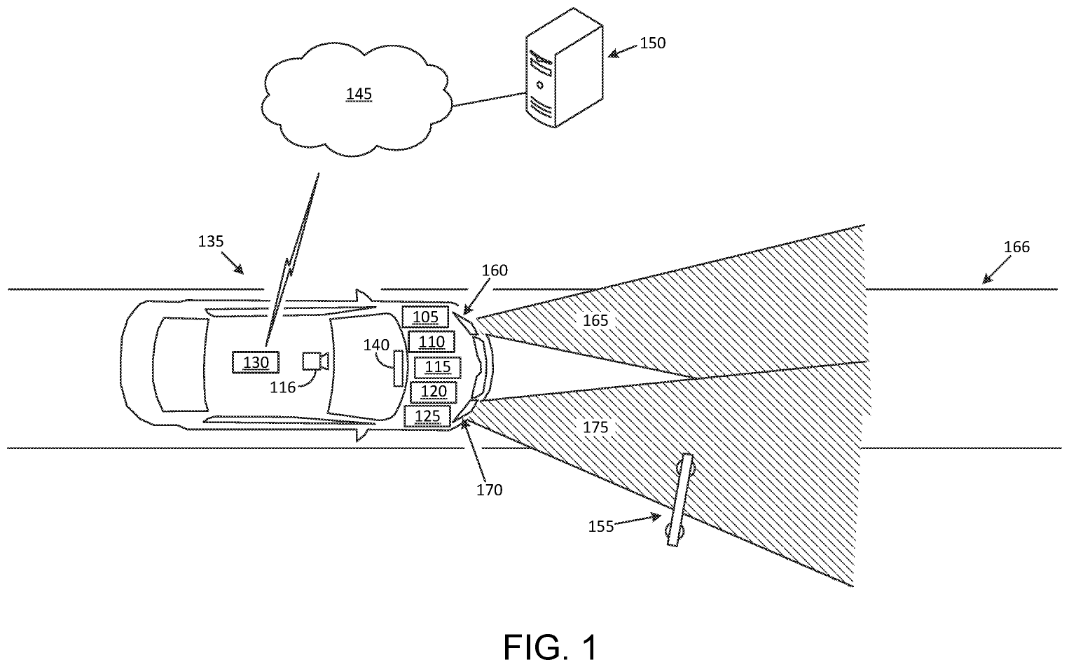

FIG. 1 shows an example vehicle 135 that is configured to perform operations associated with vehicle headlight evaluation according to an embodiment. The vehicle 135 can include various components such as, for example, a headlight evaluation system 105, a vehicle controller 110, an imaging system 115, a sensor system 120, a headlight adjustment system 125, a user interface 140, and a communication system 130. The various components are shown symbolically in block form in certain portions of the vehicle. However, it must be understood that each illustrated block can include one or more components and each component can be located at any of various locations in the vehicle 135. Additionally, the functionality of some blocks/components may be fully or partially combined.

The imaging system 115 may include an image capture control system, an image evaluation system, a camera configuration controller, and one or more cameras that are mounted at various locations on the vehicle 135 (windshield, window, cabin area, roof, license plate, trunk, side mirrors, etc.). An example camera 116 is shown mounted upon the roof of the vehicle 135 and configured to capture images of objects located ahead of the vehicle 135. The camera 116 can be, for example, a digital camera configured to capture digital images of various objects located ahead of the vehicle 135, a video camera configured to capture video clips and/or real-time video of various objects located ahead of the vehicle 135, and/or an infrared camera configured to capture images of various objects located in low-light or low-visibility conditions. In an example implementation, the camera configuration controller may set or modify camera settings (focal length, exposure, aperture, capture speed, etc.) based on information received from the headlight evaluation system 105. The information received from the headlight evaluation system 105 may be based on evaluation of one or more images provided by the camera 116 to the headlight evaluation system 105.

The sensor system 120 can include one or more sensors and/or detectors that are mounted at various locations on the vehicle 135 (bumper, trunk, front grille, roof, windshield, cabin area, roof, license plate, trunk, side mirrors, etc.). A non-exhaustive list of example sensors and/or detectors can include an object detector configured to detect various types of objects of interest located outside the vehicle 135, a radar device configured to detect and provide distance information of various types of objects of interest located outside the vehicle 135, a light imaging and ranging (LIDAR) device configured to detect and provide distance information of various types of objects of interest located outside the vehicle 135, and an ultrasonic sensor configured to detect and provide distance information of various types of objects of interest located outside the vehicle 135. An object of interest includes a surface upon which a headlight of a vehicle can project an illumination pattern that can be used in accordance with the disclosure. Some example objects include a traffic sign, a billboard located beside a road, a back panel of another vehicle, a wall of a building located close to a road, a surface of an overpass, and an overhead sign.

The vehicle controller 110 can be configured to carry out various operations associated with the vehicle 135 such as, for example, engine operations (controlling fuel injection, controlling engine temperature, controlling engine lubrication, emissions control, etc.), component operations (braking, acceleration, cruise control, cabin climate control, etc.), performance monitoring (engine performance, brakes, fluid levels, tire pressure, bulb failure, etc.) and some driving operations (cruise control, braking, lane maintenance, etc.). In an example embodiment, the vehicle controller 110 is configured to cooperate with the headlight evaluation system 105 and/or the headlight adjustment system 125 to perform some actions in accordance with the disclosure. An example operation may include controlling and/or maintaining a speed of the vehicle 135 when the headlight evaluation system 105 is performing an operation in accordance with the disclosure.

The communication system 130 can include one or more transmitters, receivers, and/or transceivers that may include circuitry located in one part of the vehicle 135 (trunk, for example) and one or more antennas located at other parts of the vehicle 135 (windows, roof, etc.). The communication system 130 can be configured to support communication between various elements in the vehicle 135 (such as, for example, between the headlight evaluation system 105 and the camera 116) and to support communication between the vehicle 135 and elements located outside the vehicle 135 (such as, for example between the headlight evaluation system 105 and a server 150). In an example embodiment, the headlight evaluation system 105 may transmit information associated with operations performed by the headlight evaluation system 105, to the server 150, via the network 145. In an example scenario, the information transmitted to the server 150 can include results of an evaluation performed upon one or both headlights of the vehicle 135. The headlight evaluation system 105 may also obtain from the server 150, via the network, information pertaining to one or both headlights of the vehicle 135 such as, for example, specification, manufacture details, dates of operations performed, etc.

The network 145 can be any of various types of networks such as, for example, a cellular network, a Wi-Fi network, or a wide area network (the Internet, for example). Communication between various elements located on the vehicle 135 can be carried out by use of wired devices and/or wireless devices. Communication between the vehicle 135 and elements located outside the vehicle 135 can be carried out by using wireless devices and wireless technologies such as, for example, Wi-Fi, cellular, and vehicle-to-everything (V2X).

The user interface 140 can be a part of an infotainment system in the vehicle 135. In an embodiment, the user interface 140 may be used by a driver (not shown) of the vehicle 135 to initiate operations carried out by the headlight evaluation system 105. The headlight evaluation system 105 can be implemented either in the form of an independent module or can be integrated into another component such as, for example, the vehicle controller 110.

In the illustration of FIG. 1, a headlight 160 that may be located on a driver side of the vehicle 135 projects a beam of light 165 towards an area in front of the vehicle 135. The beam of light 165 can produce an illumination pattern that illuminates a portion of a road 166 ahead of the vehicle 135 and objects on the road 166 ahead of the vehicle 135 such as, for example, another vehicle (not shown) moving in the same direction as the vehicle 135, an oncoming vehicle moving in a direction opposite to the direction of movement of the vehicle 135, or a damaged tire lying on the surface of the road 166.

A shape of the illumination pattern produced by the headlight 160 may be influenced by various factors such as, for example, a contour of a light guiding element in the headlight 160 that is configured for shaping and/or directing light generated by one or more light sources of the headlight 160. In one example, the light guiding element is a reflector that is located behind a light source such as a bulb or a set of LEDs, for example. The contour of the reflector can be configured to reflect light in a forward direction out of the headlight 160 in a desired illumination pattern. In another example, the light guiding element is a lens element placed in front of a light source (Xenon headlight, set of LEDs, etc.). The lens element produces a desired light illumination pattern. Various characteristics such as, for example, color, brightness, and tint of the illumination pattern can depend on the nature of one or more light sources contained in the headlight 160 (various types of bulbs and light emitting diodes (LEDs), for example).

Another headlight 170 that may be located on a passenger side of the vehicle 135 projects a beam of light 175 ahead of the vehicle 135. The beam of light 175 can produce an illumination pattern that illuminates a portion of the road 166 ahead of the vehicle 135 and objects on the road 166 ahead of the vehicle 135 such as, for example, another vehicle (not shown) moving in the same direction as the vehicle 135, a damaged tire lying on the surface of the road 166. Additionally, the beam of light 175 produced by the headlight 170 can project an illumination pattern on to a shoulder portion of the road 166 and to areas further out from the shoulder portion. Such areas can include objects such as, for example, traffic signs, barriers, people, animals, trees, and buildings. In the example scenario depicted in FIG. 1, the beam of light 175 produced by the headlight 170 illuminates a traffic sign 155 that is typically placed in a manner that renders the traffic sign 155 visible to a driver of the vehicle 135. The traffic sign 155 is an example object having a surface that can be illuminated by the headlight 170 of the vehicle 135.

In accordance with the disclosure, the camera 116 captures one or more images of the partially illuminated traffic sign 155. The image(s) can be, for example, digital image(s), a set of digital images, and/or a video clip. The headlight evaluation system 105 is configured to receive the image(s) from the camera 116 and evaluate the image(s) to determine parameters such as, for example, a headlight position status and/or a headlight orientation status of the headlight 170 in accordance with disclosure.

In an example embodiment, the evaluation can be based on determining a positional relationship between the camera 116, the headlight 170, and a surface of the traffic sign 155 that is illuminated by the headlight 170. The positional relationship may be defined by a geometric representation based on at least a height of the camera 116 with respect to a ground surface upon which the vehicle 135 is moving, a height of the headlight 170 with respect to the ground surface, and a separation distance between the headlight 170 and the surface of the traffic sign 155. Additional details pertaining to this example embodiment are provided below.

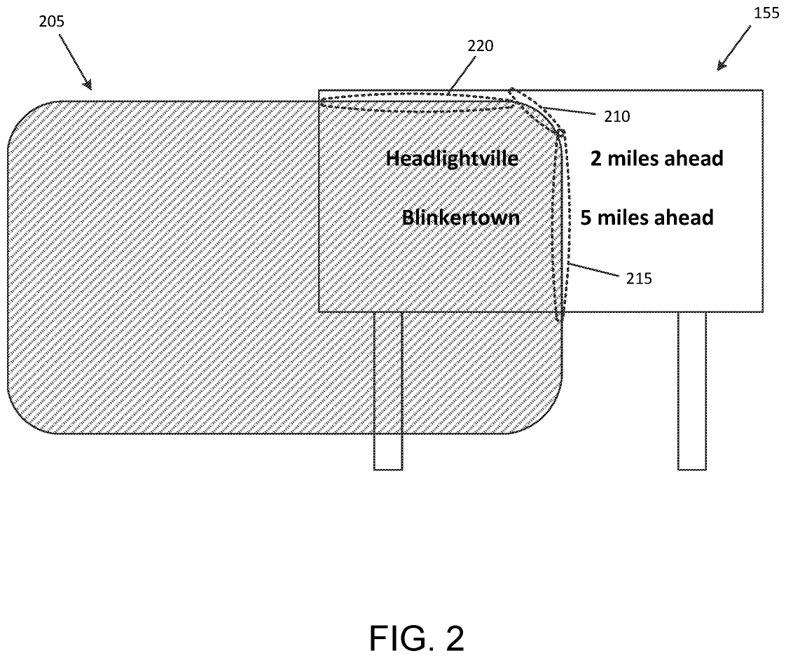

FIG. 2 illustrates an example illumination pattern 205 projected by the headlight 170 of the vehicle 135 upon the traffic sign 155. In this example scenario a surface of the traffic sign 155 is partially illuminated by the beam of light 175 produced by the headlight 170. The illumination pattern 205 may include one or more edges having various shapes. In this example, the illumination pattern 205 includes a substantially straight edge 215 oriented in a vertical direction, a substantially straight edge 220 oriented in a horizontal direction, and a curved edge 210. Each of the substantially straight edge 215 and the substantially straight edge 220 is an example of a linear edge. The curved edge 210 is one example of a non-linear edge. The curved edge 210 shown in the example illumination pattern 205 corresponds to a corner of the illumination pattern 205. However, it must be understood that a curved edge can be present at various other locations of the illumination pattern 205. A shape of the illumination pattern 205 can be influenced by various factors such as, for example, the contour of a light guiding element described above with reference to the headlight 160. A similar light guiding element may be provided in the headlight 170.

As indicated above and in accordance with the disclosure, the camera 116 captures one or more images of the partially illuminated traffic sign 155. The headlight evaluation system 105 receives the image(s) from the camera 116 and evaluate the image(s) to determine parameters such as, for example, a headlight position status and/or a headlight orientation status of the headlight 170. More particularly, the headlight evaluation system 105 can evaluate the substantially straight edge 215 to determine an orientation of the headlight 170 based on an orientation of the substantially straight edge 215. The headlight evaluation system 105 can evaluate the substantially straight edge 215, the substantially straight edge 220, and/or the curved edge 210 to determine parameters such as, for example a position of the headlight 170. The position of the headlight 170 may determine factors such as, for example, an angle of projection of the beam of light 175, a spread of the beam of light 175, and a misalignment of the headlight 170 (if present).

In an example embodiment, the headlight evaluation system 105 can perform an evaluation procedure that can include determining a distance between the headlight 170 and each of several edge points on an edge that is a part of the illumination pattern 205 and each edge point to an edge point on an envelope of a virtual light cone. The corresponding edge point on the envelope is selected on the basis of closely matching the edge point of the illumination pattern 205. The virtual light cone may be generated from one or more nominal illumination profiles/templates of the headlight 170. An example procedure for evaluating edge points can include performing multiple measurements and formulating an optimization problem for evaluating the measurements.

In an example implementation, the headlight evaluation system 105 may output a headlight position status and/or a headlight orientation status to the headlight adjusting system 125 of the vehicle 135 based on evaluating one or more sets of edge points of the illumination pattern 205. In an example implementation, the headlight evaluation system 105 may determine that the headlight position and/or the headlight orientation fails to conform to a calibration standard. In such cases, the headlight evaluation system 105 may convey the headlight position status and/or a headlight orientation status to the headlight adjusting system 125. The headlight adjusting system 125 can include components that may be operated to modify a position and/or an orientation of the headlight 170 based on the headlight position status and/or the headlight orientation status. Some example elements can include a processor, a memory, and mechanical components (servomotors, hydraulic components, levers, gears, etc.).

The traffic sign 155 is one example of a stationary object having a surface that can be used by the headlight evaluation system 105 to evaluate the headlight 170 of the vehicle 135. Many other surfaces such as, for example, a wall of a building located close to a road, a billboard located beside the road, a surface of an overpass, or an overhead sign may be used by the headlight evaluation system 105 to evaluate the headlight 170 and/or the headlight 160 of the vehicle 135.

The headlight evaluation system 105 can also be configured to evaluate the headlight 170 and/or the headlight 160 of the vehicle 135 by use of a moving object that includes a surface. One example of an evaluation of the headlight 170 and/or the headlight 160 of the vehicle 135 based on a moving object is described below.

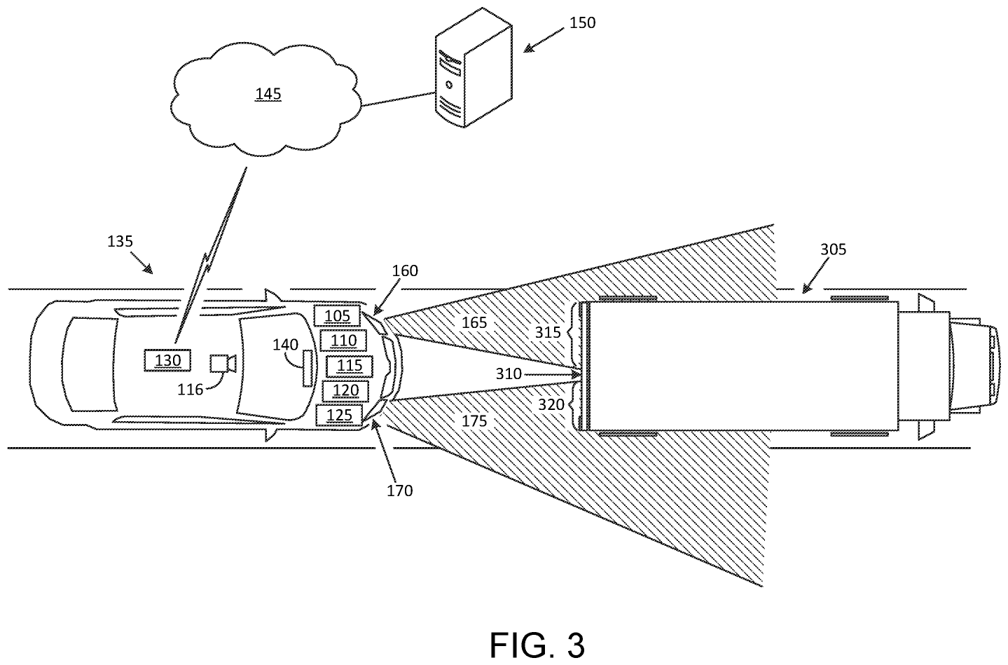

FIG. 3 illustrates an example scenario where the vehicle 135 illuminates a surface of a moving object in accordance with an embodiment of the disclosure. The moving object in this example scenario is a large vehicle 305 (a truck, a bus a van, etc.) having a rear portion that includes a flat vertical surface 310. The flat vertical surface 310, which constitutes a surface in accordance with the disclosure, can be illuminated by one or both headlights of the vehicle 135. More particularly, in this example scenario, the headlight 170 of the vehicle 135 projects a first illumination pattern upon a section 320 of the surface 310, and the headlight 160 of the vehicle 135 may concurrently project a second illumination pattern upon a section 315 of the surface 310. The first illumination pattern may be similar to, or different than, the second illumination pattern, depending upon the similarity or difference in shape, orientation, position, etc. of the headlight 170 with respect to the headlight 160. In some cases, the headlight 170 and/or the headlight 160 may be misaligned and/or out of calibration (for example, as a result of a collision, accident, manufacture, or repair).

The illumination pattern projected upon the section 320 may include features such as, for example, one or more curved edges and one or more substantially straight edges such as the edges described above with reference to illumination pattern 205 illustrated in FIG. 2. Furthermore, in the manner described above with reference to the illumination pattern 205, the headlight evaluation system 105 can evaluate image(s) captured by the camera 116 of the illumination pattern projected upon the section 320 of the flat vertical surface 310 to determine parameters such as, for example, a headlight position status and/or a headlight orientation status of the headlight 170.

The headlight evaluation system 105 may also evaluate image(s) captured by the camera 116 of the illumination pattern projected upon the section 315 of the flat vertical surface 310 to determine parameters such as, for example, a headlight position status and/or a headlight orientation status of the headlight 160. Thus, the headlight evaluation system 105 can determine various parameters of the headlight 160 and/or the headlight 170 of the vehicle 135 in accordance with the disclosure.

The illumination pattern(s) projected by the headlight(s) of the vehicle 135 upon the flat vertical surface 310 of the vehicle 305 may vary in shape, size, and location based on a separation distance between the vehicle 135 and the vehicle 305 during image capture of the illumination pattern(s). Consequently, in accordance with the disclosure, the headlight evaluation system 105 may measure a separation distance between the vehicle 135 and the vehicle 305 during capture of image(s) and may use the measured separation distance to evaluate the headlight 160 of the vehicle 135. The separation distance between the vehicle 135 and the vehicle 305 may be measured in any of various way. For example, the camera 116 can be a monocular camera that may be used to perform a monocular camera depth estimation to determine the separation distance. In an example implementation, the separation distance can be calculated based on factors such as, for example, time between separation distance measurements, scale changes of captured images of the illumination pattern, and a speed of the vehicle 135. The speed of the vehicle 135 can be obtained by the headlight evaluation system 105 from the vehicle controller 110 or a speedometer of the vehicle 135.

Another way to measure the separation distance can be based on use of a camera (the camera 116, for example) configured to provide stereo vision information to the headlight evaluation system 105. Yet another way to measure the separation distance can be based on use of one or more components of the sensor system 120 of the vehicle 135 (radar, sonar, LIDAR, etc.). In an example embodiment, each separation distance measurement corresponds to a separation distance between the headlight 170 and each of several edge points of the illumination pattern 320 and/or to a separation distance between the headlight 160 and each of several edge points of the illumination pattern 315. Virtual light cones corresponding to nominal illumination profiles/templates of the headlight 170 and/or headlight 160 can be used for evaluating the headlight position status and/or headlight orientation status of the headlight 170 and/or the headlight 160.

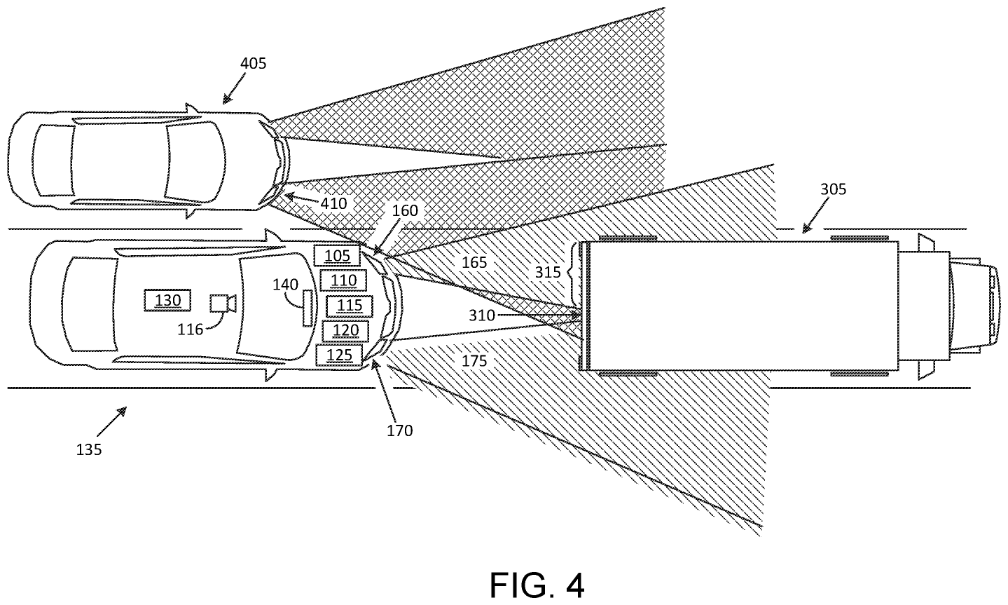

FIG. 4 illustrates an example scenario where a first illumination pattern projected by the vehicle 135 upon a surface of an object is overlapped by a second illumination pattern projected upon the surface by another vehicle 405. In this example scenario, the object is a moving object (vehicle 305). However, it must be understood that the description below with respect to the moving object is equally applicable to a stationary object such as, for example, the traffic sign 155 described above. The second illumination pattern may be produced by a headlight 410 of a vehicle 405 that may be traveling in a lane adjacent to the lane in which the vehicle 135 is traveling. The headlight evaluation system 105 may detect the overlapping illumination pattern based on evaluating one or more images of the surface 310 and may avoid, halt, or pre-empt evaluating the illumination pattern projected by the headlight 160 of the vehicle 135.

Alternatively, the headlight evaluation system 105 may distinguish and identify the first illumination pattern projected by the headlight 160 of the vehicle 135, based on evaluating the overlapping illumination pattern. In an example implementation of such a procedure, the headlight evaluation system 105 may evaluate multiple edge points in the overlapping illumination pattern (in the manner described above), and distinguish the illumination pattern produced by the headlight 160 of the vehicle 135 from the illumination pattern produced by the headlight 410 of the vehicle 405.

The headlight evaluation system 105 may also avoid false edge detection, by correlating a movement of the first illumination pattern projected by the headlight 160 of the vehicle 135 with a movement of the vehicle 135. For example, the headlight evaluation system 105 may evaluate a set of images (a video clip, for example) and determine that the edge 220 shown in FIG. 2 is moving up and down in correspondence to a movement of the vehicle 135 when the vehicle 135 moves over a road bump or a pothole on the road, for example. Based on this correlation, the headlight evaluation system 105 can deduce that the edge that is detected is indeed the edge 220.

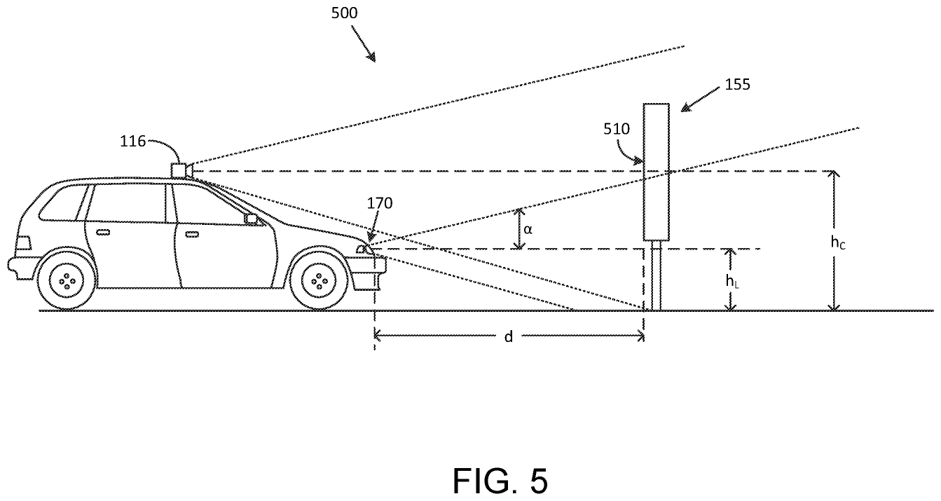

FIG. 5 illustrates a geometric representation 500 that defines a positional relationship between the vehicle 135 and a surface 510 of an object (in this example, the traffic sign 155). It must be understood that the description below with respect to the traffic sign 155 is equally pertinent to a surface of a moving object such as, for example, the flat vertical surface 310 of the vehicle 305 described above.

More particularly, if a drift in a roll angle of an illumination pattern is assumed to be negligible, a pitch of the illumination pattern can be represented by the geometric representation 500 as follows:

$${d}_{L} tan α = \frac{{d}_{C}}{f} ( {v}_{p} - v ) + {h}_{C} - {h}_{L}$$

where “d_{L}” indicates a distance between the headlight 170 and the surface 510 of the traffic sign 155, “d_{C}” indicates a distance between the camera 116 and the surface 510 of the traffic sign 155, “h_{C}” indicates a height of the camera 116 above ground, “h_{L}” indicates a height of the headlight 170 above ground, “f” is a focal length of the camera 116 (which can be assumed to be a pinhole camera), “vₚ” indicates a vertical position of the principal point of the camera 116 in a captured image, “v” indicates a vertical position of a detected edge in the captured image, and α=α_{L}+αₚ (where “α_{L}” is a known elevation of an expected edge with reference to an axis of the headlight 170, and “α_{P}” is headlight pitch). The headlight pitch is one example of a parameter that can be determined by the headlight evaluation system 105.

In another implementation, some of the parameters of the geometric representation 500 that are described above with reference to ground are instead referenced to a component of the vehicle 135 (an axle of the vehicle 135, for example). In this case, “h_{C}” indicates a height of the camera 116 with respect to the component of the vehicle 135 and “h_{L}” indicates a height of the headlight 170 with respect to the component of the vehicle 135.

In another implementation, some of the parameters of the geometric representation 500 that are described above with reference to ground or a component of the vehicle 135, are instead referenced to each other. The geometric representation 500 in this case is as follows:

$${d}_{L} tan α = \frac{{d}_{C}}{f} ( {v}_{p} - v ) + Δ z$$

where Δz is a vertical separation distance between the camera 116 and the headlight 170.

A yaw angle may be determined by use of the geometric representation 500 as follows:

$${d}_{L} tan β = \frac{{d}_{C}}{f} ( {u}_{p} - u ) + Δ y$$

where “u” represents horizontal image coordinates and Δy represents a horizontal separation orthogonal to the optical axis of the camera 116.

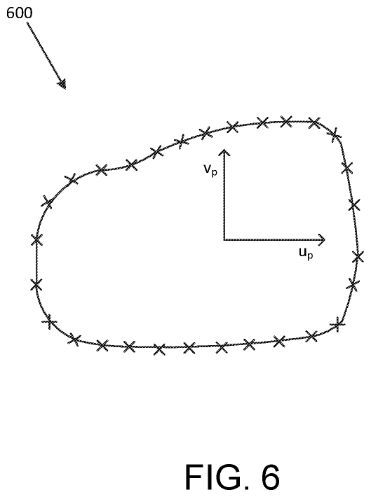

FIG. 6 shows a geometric representation 600 that may be used for evaluating an illumination pattern in accordance with the disclosure. The geometric representation 600 includes “N” light profile edge points and represents a general case where various parameters that may be used to describe an orientation and position of a headlight is potentially unknown. The parameters may be estimated by solving an optimization expression by use of algorithms such as, for example, gradient descent, Levenberg-Marquardt, or Broyden-Fletcher-Goldfarb-Shannon (BFGS). In one embodiment, various parameters may be identified based on the following expression:

$$\hat{p} = {arg min}_{p} {\sum }_{k}^{M} {min}_{i = 1 … S , j = 1 … N} D ( P ( {e}_{i , j} , p ) , T ( {m}_{k} , c ) , {w}_{k} ) )$$

where “S” represents a number of light sources (such as, for example, the headlight 160 and the headlight 170), “N” represents a number of light profile edge points, “M” represents a number of illumination edge point measurements, “p” represents parameters to be estimated (angles, positions, etc.), “e” represents light profile edge points (uₚ, vₚ), “m” represents measurements (u, v, distance) collected over multiple image frames, “w” represents measurement weights, “C” represents camera parameters, “T” represents image-to-world transformation ((u, v, distance) into (x, y, z) world coordinates), “P” represents a projection of light profile edge points into lines of light in the real world (uₚ, vₚ into lines that form a virtual light cone), and “D” represents weighted distance between a line and a point.

In some embodiments, an orientation of a headlight of a vehicle may be calculated based on supplementing, complementing, or replacing the procedures described above with reference to the geometric representation 600 with procedures such as, for example, time filtering or standard optimization procedures applied upon a larger number of data points.

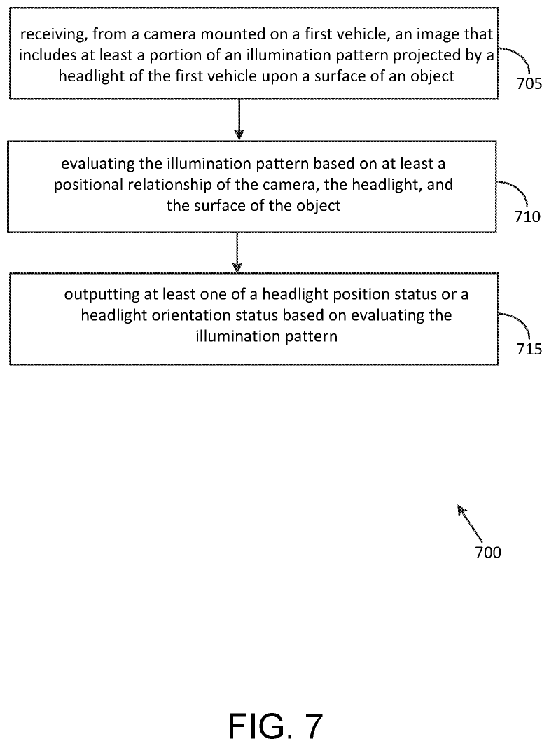

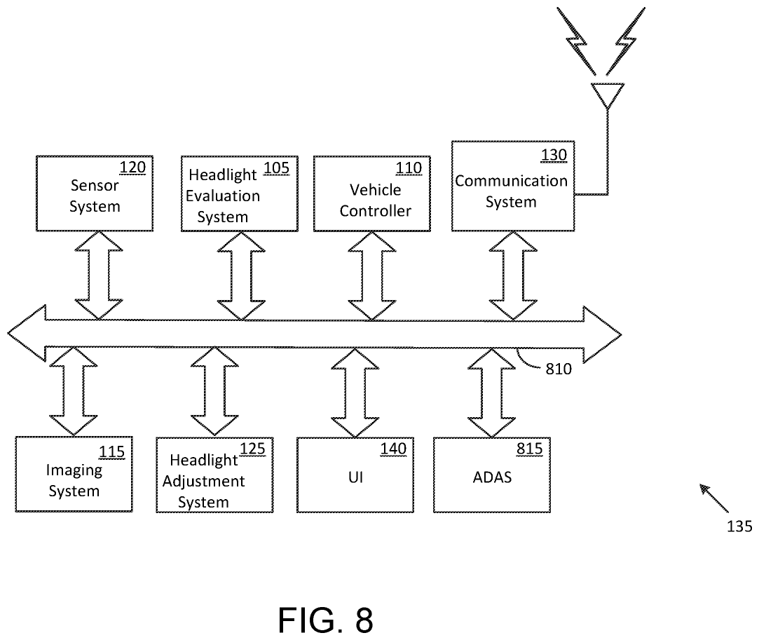

FIG. 7 shows a flow diagram 700 of a method to evaluate a headlight of a vehicle in accordance with an embodiment of the disclosure. Means for performing the functionality illustrated in one or more of the blocks shown in FIG. 7 may be performed by hardware and/or software components of the various components such as the components illustrated in FIGS. 1-4. In some examples, various components of a vehicle, such as, for example, the vehicle 135 described above, may perform the functionality illustrated in one or more of blocks of the flow diagram 700 in an operating environment such as illustrated in FIGS. 1-4 described above. Example components of a vehicle are illustrated in FIG. 8 and described below in more detail. The description below refers to various example components described herein but it must be understood that the functions can be performed by various other components that may be functionally identical or functionally similar.

At block 705, the functionality can include receiving from a camera mounted on a first vehicle, at least one image that includes at least a portion of an illumination pattern projected by a headlight of the first vehicle upon a surface of an object. In an example scenario described above, the camera is the camera 116 that captures one or more images of the example illumination pattern 205 projected by the headlight 170 of the vehicle 135 upon the traffic sign 155.

At block 710, the functionality can include evaluating the illumination pattern based on at least a positional relationship of the camera, the headlight, and the surface of the object. In an example implementation, the positional relationship of the camera, the headlight, and the surface of the object can be defined by a geometric representation such as the example ones indicated above. In an example implementation, the illumination pattern may be evaluated based on evaluating a set of edge points contained in at least one image in a set of images of the illumination pattern to determine a location and/or an orientation of the headlight. Evaluating the set of edge points can include filtering and/or aggregating information associated with one or more edge points. The set of edge points can correspond, for example, to a substantially straight edge and/or a non-linear edge that is a part of the illumination pattern.

In an example implementation, the illumination pattern may be evaluated based on identifying light projected upon the surface of the object by a second vehicle and omitting evaluation of images that include light projected upon the surface of the object by the second vehicle.

At block 715, the functionality can include outputting a headlight position status and/or a headlight orientation status based on evaluating the illumination pattern. In an example implementation, the headlight position status and/or headlight orientation status can be output to the headlight adjusting system 125 of the vehicle 135, a camera configuration controller of the vehicle 135, or an advanced driver assistance system (ADAS) of the vehicle 135.

FIG. 8 is a block diagram of various hardware and software components of the vehicle 135, according to an embodiment. Some of the example components that are described herein can include the headlight evaluation system 105, the vehicle controller 110, the imaging system 115, the sensor system 120, the headlight adjustment system 125, the communication system 130, the user interface 140, and an advanced driver-assistance system (ADAS) 815. It should be noted that FIG. 8 is meant only to provide a generalized illustration of various components, any or all of which may be utilized as appropriate.

The various components are communicatively coupled to each other via a bus 810, which can be implemented in various ways, such as, for example, in the form of a vehicle bus using any of various formats such as CAN, FlexRay, MOST, etc.

Some elements of the headlight evaluation system 105 have been described above with reference to FIG. 1. The headlight evaluation system 105 can include one or more processors, which can be, without limitation one or more general-purpose processors, one or more special-purpose processors (such as DSP chips, graphics processors (GPUs), application specific integrated circuits (ASICs), and/or the like), and/or other processor, processing structure, processing unit, or processing means. In some embodiments, the processors can be configured to replace, complement, or supplement one or more processors provided in the vehicle controller 110 and/or in the headlight adjustment system 125 for performing various operations in accordance with the disclosure.

The communication system 130 may include one or more wireless transmitters, receivers, and/or transceivers and may further include a wireless communication interface, which may comprise without limitation a modem, a network card, an infrared communication device, a wireless communication device, and/or a chipset. Some example devices that may be also included in the communication system 130 can be a Bluetooth® device, an IEEE 802.11 device, an IEEE 802.15.4 device, a Wi-Fi device, a WiMAX™ device, a Wide Area Network (WAN) device, various cellular devices, etc.), V2X communication devices, satellite communication devices, and/or the like, which may enable the communication system 130 to communicate via networks, and/or directly, with other devices as described herein. The wireless communication interface may permit data and signaling to be communicated (e.g. transmitted and received) with a network, for example, via WAN access points, cellular base stations and/or other access node types, and/or other network components, computer systems, and/or any other electronic devices described herein. The communication can be carried out via one or more wireless communication antenna(s) that send and/or receive wireless signals. The wireless communication antenna(s) may comprise one or more discrete antennas, one or more antenna arrays, or any combination.

It will be apparent to those skilled in the art that substantial variations may be made in accordance with specific requirements. For example, in some implementations, customized hardware may be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A method of headlight calibration, comprising: receiving, from a camera mounted on a first vehicle, at least one image that includes at least a portion of an illumination pattern projected by a headlight of the first vehicle upon a surface of an object; evaluating the illumination pattern based on at least a positional relationship of the camera, the headlight, and the surface of the object; and outputting at least one of a headlight position status or a headlight orientation status based on evaluating the illumination pattern.

Clause 2. The method of clause 1, wherein the positional relationship is defined by a geometric representation that includes at least a height of the camera with respect to one of a ground surface or a component of the first vehicle, a height of the headlight with respect to the one of the ground surface or the component of the first vehicle, and a separation distance between the surface of the object and at least one of the headlight or the camera.

Clause 3. The method of clause 1, wherein the positional relationship is based, at least in part, on a set of separation distances between the camera, the headlight, and the surface of the object.

Clause 4. The method of any of clauses 1 through 3, wherein the at least one image comprises a set of images, and wherein evaluating the illumination pattern further comprises evaluating a set of edge points contained in at least one image in the set of images to determine at least one of a location or an orientation of the headlight, wherein evaluating the set of edge points comprises filtering and/or aggregating information associated with at least one edge point.

Clause 5. The method of any of clauses 1 through 4, wherein the at least the portion of the illumination pattern includes a substantially straight edge, and the method further comprises outputting the at least one of the headlight position status or the headlight orientation status based on evaluating the substantially straight edge.

Clause 6. The method of clause 5, wherein evaluating the substantially straight edge comprises determining an orientation of the substantially straight edge, and wherein outputting the at least one of the headlight position status or the headlight orientation status comprises outputting the at least one of the headlight position status or the headlight orientation status to at least one of a headlight adjusting system of the first vehicle, a camera configuration controller of the first vehicle, or an advanced driver assistance system (ADAS) of the first vehicle.

Clause 7. The method of any of clauses 1 through 3, wherein the at least the portion of the illumination pattern includes an edge having a non-linear shape, and the method further comprises generating the at least one of the headlight position status or the headlight orientation status based on evaluating the edge having the non-linear shape.

Clause 8. The method of any of clauses 1 through 7, further comprising evaluating the illumination pattern projected by the headlight of the first vehicle based on identifying light projected upon the surface of the object by a second vehicle.

Clause 9. The method of clause 8, wherein evaluating the illumination pattern comprises omitting evaluation of images that include light projected upon the surface of the object by the second vehicle.

Clause 10. The method of clause 3, wherein the first vehicle is in motion and wherein the method further comprises receiving, from the camera mounted on the first vehicle, a set of images of the illumination pattern; and determining at least one of the set of separation distances between the camera, the headlight, and the surface of the object, based on evaluating the set of images.

Clause 11. The method of clause 3, wherein the object is a moving object and the method further comprises determining a speed of the moving object; and determining at least one of the set of separation distances between the camera, the headlight, and the surface of the moving object based at least in part on the speed of the moving object.

Clause 12. The method of any of clauses 1 through 11, wherein the object is one of a traffic sign, a road sign, a billboard, or a back panel of another vehicle.

Clause 13. An apparatus for headlight calibration, comprising a camera mounted on a vehicle; a headlight calibration evaluation system comprising a memory and one or more processors communicatively coupled with the memory, the one or more processors configured to receiving, from the camera, at least one image that includes at least a portion of an illumination pattern projected by a headlight of the vehicle upon a surface of an object; evaluating the illumination pattern based on at least a positional relationship of the camera, the headlight, and the surface of the object; and outputting at least one of a headlight position status or a headlight orientation status based on evaluating the illumination pattern.

Clause 14. The apparatus of clause 13, wherein the positional relationship is defined by a geometric representation that includes at least a height of the camera with respect to one of a ground surface or a component of the vehicle, a height of the headlight with respect to the one of the ground surface or the component of the vehicle, and a separation distance between the surface of the object and at least one of the headlight or the camera.

Clause 15. The apparatus of clause 13, wherein the positional relationship is based, at least in part, on a set of separation distances between the camera, the headlight, and the surface of the object.

Clause 16. The apparatus of any of clauses 13 through 15, wherein the at least one image comprises a set of images, and wherein evaluating the illumination pattern further comprises evaluating a set of edge points contained in at least one image in the set of images to determine at least one of a location or an orientation of the headlight, wherein evaluating the set of edge points comprises filtering and/or aggregating information associated with at least one edge point.

Clause 17. The apparatus of any of clauses 13 through 16, wherein the at least the portion of the illumination pattern includes a substantially straight edge and wherein evaluating the substantially straight edge comprises determining an orientation of the substantially straight edge.

Clause 18. The apparatus of any of clauses 13 through 17, further comprising a headlight adjusting system provided in the vehicle, the one or more processors further configured to output the at least one of the headlight position status or the headlight orientation status to at least one of the headlight adjusting system, a camera configuration controller of the vehicle, or an advanced driver assistance system (ADAS) of the vehicle.

Clause 19. The apparatus of any of clauses 13 through 18, wherein evaluating the illumination pattern projected by the headlight of the vehicle includes identifying light projected upon the surface of the object by another vehicle.

Clause 20. The apparatus of clause 19, wherein evaluating the illumination pattern comprises omitting evaluation of images that include light projected upon the surface of the object by another vehicle.

Clause 21. An apparatus for headlight calibration, comprising means for receiving, from a camera mounted on a first vehicle, at least one image that includes at least a portion of an illumination pattern projected by a headlight of the first vehicle upon a surface of an object; means for evaluating the illumination pattern based on at least a positional relationship of the camera, the headlight, and the surface of the object; and means for outputting at least one of a headlight position status or a headlight orientation status based on evaluating the illumination pattern.

Clause 22. The apparatus of clause 21, wherein the positional relationship is defined by a geometric representation that includes at least a height of the camera with respect to one of a ground surface or a component of the first vehicle, a height of the headlight with respect to the one of the ground surface or the component of the first vehicle, and a separation distance between the surface of the object and at least one of the headlight or the camera.

Clause 23. The apparatus of clause 21, wherein the positional relationship is based, at least in part, on a set of separation distances between the camera, the headlight, and the surface of the object.

Clause 24. The apparatus of any of clauses 21 through 23, wherein the at least one image comprises a set of images, and wherein evaluating the illumination pattern further comprises evaluating a set of edge points contained in at least one image in the set of images to determine at least one of a location or an orientation of the headlight, wherein evaluating the set of edge points comprises filtering and/or aggregating information associated with at least one edge point.

Clause 25. The apparatus of any of clauses 21 through 24, wherein the at least the portion of the illumination pattern includes a substantially straight edge, the instructions further comprising code for outputting the at least one of the headlight position status or the headlight orientation status based on evaluating the substantially straight edge.

Clause 26. The apparatus of clause 25, wherein evaluating the substantially straight edge comprises determining an orientation of the substantially straight edge, and wherein outputting the at least one of the headlight position status or the headlight orientation status comprises outputting the at least one of the headlight position status or the headlight orientation status to at least one of a headlight adjusting system of the first vehicle, a camera configuration controller of the first vehicle, or an advanced driver assistance system (ADAS) of the first vehicle.

Clause 27. The apparatus of any of clauses 21 through 24, wherein the at least the portion of the illumination pattern includes an edge having a non-linear shape, and the instructions further comprising code for generating the at least one of the headlight position status or the headlight orientation status based on evaluating the edge having the non-linear shape.

Clause 28. A non-transitory computer-readable medium storing instructions for headlight calibration, the instructions comprising code for receiving, from a camera mounted on a first vehicle, at least one image that includes at least a portion of an illumination pattern projected by a headlight of the first vehicle upon a surface of an object; evaluating the illumination pattern based on at least a positional relationship of the camera, the headlight, and the surface of the object; and outputting at least one of a headlight position status or a headlight orientation status based on evaluating the illumination pattern.

Clause 29. The non-transitory computer-readable medium of clause 28, wherein the positional relationship is defined by a geometric representation that includes at least a height of the camera with respect to one of a ground surface or a component of the first vehicle, a height of the headlight with respect to the one of the ground surface or the component of the first vehicle, and a separation distance between the surface of the object and at least one of the headlight or the camera.

Clause 30. The non-transitory computer-readable medium of claim 28, wherein the positional relationship is based, at least in part, on a set of separation distances between the camera, the headlight, and the surface of the object.

What is claimed is:

1. A method of headlight calibration, comprising:
receiving, from a camera mounted on a first vehicle, at least one image that includes at least a portion of an illumination pattern projected by a headlight of the first vehicle upon a surface of an object;
evaluating the illumination pattern based on at least a positional relationship of the camera, the headlight, and the surface of the object; and
outputting at least one of a headlight position status or a headlight orientation status based on evaluating the illumination pattern.

2. The method of claim 1, wherein the positional relationship is defined by a geometric representation that includes at least a height of the camera with respect to one of a ground surface or a component of the first vehicle, a height of the headlight with respect to the one of the ground surface or the component of the first vehicle, and a separation distance between the surface of the object and at least one of the headlight or the camera.

3. The method of claim 1, wherein the positional relationship is based, at least in part, on a set of separation distances between the camera, the headlight, and the surface of the object.

4. The method of claim 3, wherein the at least one image comprises a set of images, and wherein evaluating the illumination pattern further comprises:
evaluating a set of edge points contained in at least one image in the set of images to determine at least one of a location or an orientation of the headlight, wherein evaluating the set of edge points comprises filtering and/or aggregating information associated with at least one edge point.

5. The method of claim 3, wherein the at least the portion of the illumination pattern includes a substantially straight edge, and the method further comprises:
outputting the at least one of the headlight position status or the headlight orientation status based on evaluating the substantially straight edge.

6. The method of claim 5, wherein evaluating the substantially straight edge comprises determining an orientation of the substantially straight edge, and wherein outputting the at least one of the headlight position status or the headlight orientation status comprises outputting the at least one of the headlight position status or the headlight orientation status to at least one of a headlight adjusting system of the first vehicle, a camera configuration controller of the first vehicle, or an advanced driver assistance system (ADAS) of the first vehicle.

7. The method of claim 3, wherein the at least the portion of the illumination pattern includes an edge having a non-linear shape, and the method further comprises:
generating the at least one of the headlight position status or the headlight orientation status based on evaluating the edge having the non-linear shape.

8. The method of claim 3, further comprising:
evaluating the illumination pattern projected by the headlight of the first vehicle based on identifying light projected upon the surface of the object by a second vehicle.

9. The method of claim 8, wherein evaluating the illumination pattern comprises:
omitting evaluation of images that include light projected upon the surface of the object by the second vehicle.

10. The method of claim 3, wherein the first vehicle is in motion and wherein the method further comprises:
receiving, from the camera mounted on the first vehicle, a set of images of the illumination pattern; and
determining at least one of the set of separation distances between the camera, the headlight, and the surface of the object, based on evaluating the set of images.

11. The method of claim 3, wherein the object is a moving object and the method further comprises:
determining a speed of the moving object; and
determining at least one of the set of separation distances between the camera, the headlight, and the surface of the moving object based at least in part on the speed of the moving object.

12. The method of claim 1, wherein the object is one of a traffic sign, a road sign, a billboard, or a back panel of another vehicle.

13. An apparatus for headlight calibration, comprising:
a camera mounted on a vehicle;
a headlight calibration evaluation system comprising:
a memory; and
one or more processors communicatively coupled with the memory, the one or more processors configured to:
receiving, from the camera, at least one image that includes at least a portion of an illumination pattern projected by a headlight of the vehicle upon a surface of an object;
evaluating the illumination pattern based on at least a positional relationship of the camera, the headlight, and the surface of the object; and
outputting at least one of a headlight position status or a headlight orientation status based on evaluating the illumination pattern.

14. The apparatus of claim 13, wherein the positional relationship is defined by a geometric representation that includes at least a height of the camera with respect to one of a ground surface or a component of the vehicle, a height of the headlight with respect to the one of the ground surface or the component of the vehicle, and a separation distance between the surface of the object and at least one of the headlight or the camera.

15. The apparatus of claim 13, wherein the positional relationship is based, at least in part, on a set of separation distances between the camera, the headlight, and the surface of the object.

16. The apparatus of claim 15, wherein the at least one image comprises a set of images, and wherein evaluating the illumination pattern further comprises:
evaluating a set of edge points contained in at least one image in the set of images to determine at least one of a location or an orientation of the headlight, wherein evaluating the set of edge points comprises filtering and/or aggregating information associated with at least one edge point.

17. The apparatus of claim 13, wherein the at least the portion of the illumination pattern includes a substantially straight edge and wherein evaluating the substantially straight edge comprises determining an orientation of the substantially straight edge.

18. The apparatus of claim 13, further comprising:
a headlight adjusting system provided in the vehicle, the one or more processors further configured to output the at least one of the headlight position status or the headlight orientation status to at least one of the headlight adjusting system, a camera configuration controller of the vehicle, or an advanced driver assistance system (ADAS) of the vehicle.

19. The apparatus of claim 13, wherein evaluating the illumination pattern projected by the headlight of the vehicle includes identifying light projected upon the surface of the object by another vehicle.

20. The apparatus of claim 13, wherein evaluating the illumination pattern comprises:
omitting evaluation of images that include light projected upon the surface of the object by another vehicle.

21. An apparatus for headlight calibration, comprising:
means for receiving, from a camera mounted on a first vehicle, at least one image that includes at least a portion of an illumination pattern projected by a headlight of the first vehicle upon a surface of an object;
means for evaluating the illumination pattern based on at least a positional relationship of the camera, the headlight, and the surface of the object; and
means for outputting at least one of a headlight position status or a headlight orientation status based on evaluating the illumination pattern.

22. The apparatus of claim 21, wherein the positional relationship is defined by a geometric representation that includes at least a height of the camera with respect to one of a ground surface or a component of the first vehicle, a height of the headlight with respect to the one of the ground surface or the component of the first vehicle, and a separation distance between the surface of the object and at least one of the headlight or the camera.

23. The apparatus of claim 21, wherein the positional relationship is based, at least in part, on a set of separation distances between the camera, the headlight, and the surface of the object.

24. The apparatus of claim 23, wherein the at least one image comprises a set of images, and wherein evaluating the illumination pattern further comprises:
evaluating a set of edge points contained in at least one image in the set of images to determine at least one of a location or an orientation of the headlight, wherein evaluating the set of edge points comprises filtering and/or aggregating information associated with at least one edge point.

25. The apparatus of claim 23, wherein the at least the portion of the illumination pattern includes a substantially straight edge, the instructions further comprising code for:
outputting the at least one of the headlight position status or the headlight orientation status based on evaluating the substantially straight edge.

26. The apparatus of claim 25, wherein evaluating the substantially straight edge comprises determining an orientation of the substantially straight edge, and wherein outputting the at least one of the headlight position status or the headlight orientation status comprises outputting the at least one of the headlight position status or the headlight orientation status to at least one of a headlight adjusting system of the first vehicle, a camera configuration controller of the first vehicle, or an advanced driver assistance system (ADAS) of the first vehicle.

27. The apparatus of claim 23, wherein the at least the portion of the illumination pattern includes an edge having a non-linear shape, and the instructions further comprising code for:
generating the at least one of the headlight position status or the headlight orientation status based on evaluating the edge having the non-linear shape.

28. A non-transitory computer-readable medium storing instructions for headlight calibration, the instructions comprising code for:
receiving, from a camera mounted on a first vehicle, at least one image that includes at least a portion of an illumination pattern projected by a headlight of the first vehicle upon a surface of an object;
evaluating the illumination pattern based on at least a positional relationship of the camera, the headlight, and the surface of the object; and
outputting at least one of a headlight position status or a headlight orientation status based on evaluating the illumination pattern.

29. The non-transitory computer-readable medium of claim 28, wherein the positional relationship is defined by a geometric representation that includes at least a height of the camera with respect to one of a ground surface or a component of the first vehicle, a height of the headlight with respect to the one of the ground surface or the component of the first vehicle, and a separation distance between the surface of the object and at least one of the headlight or the camera.

30. The non-transitory computer-readable medium of claim 28, wherein the positional relationship is based, at least in part, on a set of separation distances between the camera, the headlight, and the surface of the object.
